(19) United States
(12) Patent Application Publication
(10) Pub. No.: US 2020/0373113 A1
(43) Pub. Date: Nov. 26, 2020

(54) Separating Device For A Surge Arrester And Arrangement

(71) Applicant: SIEMENS AKTIENGESELLSCHAFT, MUENCHEN (SE)

(72) Inventors: THOMAS KOCH, BRIESELANG (DE); BERND KRUSKA, BERLIN (DE); WERNER LESSE, BERLIN (DE); MATTHIAS SCHUBERT, BERLIN (DE); JOERG TEICHMANN, DALLGOW-DOEBERITZ (DE)

(21) Appl. No.: 16/454,798

(22) Filed: Jun. 27, 2019

(30) Foreign Application Priority Data
May 22, 2019 (DE) 102019207465.0

(51) Int. Cl. H01H 85/44; H01H 85/30; H01H 85/20; H01H 85/17

(52) U.S. Cl. CPC H01H 85/44; H01H 85/17; H01H 85/205; H01H 85/303

(57) ABSTRACT

A separating device for a surge arrester has a housing and a fuse is arranged in the housing. There is also described an arrangement that includes a surge arrester and a separating device as described.

The invention relates to a separating device for a surge arrester according to the precharacterizing clause of claim 1, and to an arrangement having a surge arrester and a separating device as claimed in claim 13.

Surge arresters are used in the medium-voltage and high-voltage fields in order to safely dissipate so-called surges, i.e. voltages far above the rated voltages intended during operation, to ground. In this way, damage to equipment, for example transformers, is avoided. For example, a surge arrester for high voltage may be arranged on an overhead line and safely limit impermissibly high voltages in the event of a lightning strike or switching processes in the network.

Surge arresters generally contain so-called varistors, i.e. electrical resistors whose electrical resistance is very high up to a design-dictated threshold voltage and is greatly reduced above the threshold voltage, so that the surge arrester becomes a good electrical conductor. For example, metal oxide resistors in the form of disks are arranged above one another in a housing and connected at the respective ends of the housing to the high-voltage potential and the ground potential. In this case, the surge arrester conducts very little during regular operation, so that only a small leakage current flows to ground. In the event of a fault, however, a high discharge current flows.

During long-term operation of a surge arrester, however, damage may occur on or in the arrester which leads to a short-circuit current flowing through the arrester which is so large that evolution of gas takes place inside the arrester. In this case, an arrester may be damaged in such a way that it forms a permanent short circuit.

In order to prevent this, so-called separating devices are often used. In the event of a current flow which exceeds a certain duration and strength (the limits are dictated by the design of the separating device), these separating devices trigger a blank cartridge by an arc discharge. The blank cartridge is to this end provided in a fluid-tight chamber which, when the cartridge is triggered, is filled with gas flowing out and is thus pressurized. The pressure in the chamber subsequently ruptures the housing wall in the manner of a pipe bomb.

Explosion of the blank cartridge breaks the housing of the separating device and, for example, splits off a connected ground cable. In this way, permanent electrical separation is achieved.

A problem with this, however, is that during the explosion the separating device may throw out hot particles and splinters which fall to the ground and may start fires there. This problem is relevant particularly in Australia and the arid regions of the USA, since there is a constant risk of bush fires there which rapidly spread over a large distance and may cause damage to property and people.

From document EP 0729 209 B1, it is known to configure a separating device in such a way that hot particles and splinters are retained inside the separating device after explosion of the blank cartridge. This is achieved by arranging the housing to be ruptured by the blank cartridge in a bell-shaped collecting funnel. This collecting funnel is in turn arranged in a tube that is open downward. However, the lower, open end of the tube comprises a construction. Ventilation openings are provided in the tube, which contribute to limiting an overpressure during the explosion. When the blank cartridge explodes, the collecting funnel is propelled away and moved downward in the tube. Many hot particles and splinters are retained in the tube. The movement of the collecting funnel ends when the collecting funnel encounters the narrow point; ejection from the tube is prevented.

A refinement is known from the previously unpublished German patent application no. 10 2018 209 741.0 of Jun. 18, 2018. In this, a piston is intended to be moved in the event of rupture of a second housing because of an explosive effect inside a first housing, so as to form a separating gap, at least a part of the inner side of the first housing facing toward the separating gap comprising an arc-quenching material. The arc-quenching material limits soot formation by the arc discharge and prevents formation of an electrically conductive layer on the inner side of the first housing.

It is furthermore known that, in surge arresters, devices are used which, in the event of a fault, force an arc discharge occurring between two electrodes to rotate in order to reduce flying sparks. They cannot, however, prevent the surge arrester from continuing to represent a short circuit in the network. These devices are often referred to as arc projection systems. For example, such systems are known from the documents WO 2013/000803 A1 and WO 2013/000804 A1.

On the basis of the known separating device, the object of the invention is to specify a separating device for a surge arrester, this device comparatively being particularly compact, safe and economical to manufacture.

The invention achieves this object by a separating device as claimed in claim 1.

Fuses are known, for example, from Wikipedia (permanent link: https://de.wikipedia.org/w/index.php?title=Schmelzsicherung&oldid=187704271). Within the scope of the invention, high-voltage/high-power fuses (HH fuses) may for example be used. Such fuses comprise for example a fusible part, for example a thin fusible wire made of a metal, for example of silver or copper. The fusible part is furthermore enclosed by an arc-quenching material, for example quartz sand. Fuses of this type have not previously been used for separating devices of surge arresters, inter alia because, in order to be usable on an arrester, they would need to be made long enough to comply with the required insulating distances in air.

In one preferred embodiment of the separating device according to the invention, the fuse comprises for the event of tripping an electrical conductor which can melt as a result of a heating effect of a current flow, and also an insulating material which encloses the conductor. The electrical conductor, or the fusible part, may for example comprise a thin fusible wire made of a metal, for example of silver or copper. For example, sand or quartz sand may be used as the insulating material.

In another preferred embodiment of the separating device according to the invention, the housing at least partially comprises a glass fiber-reinforced plastic. This is an advantage because previous HH fuses typically comprise a cylindrical porcelain body which is relatively heavy and susceptible to fracture. The use of glass fiber-reinforced plastic (GFRP), for example in the form of a tube, is lightweight and relatively flexurally strong. This is advantageous in particular when the separating device is intended to be configured as a holding device for the arrester, so that bending forces may be absorbed.

In another preferred embodiment of the separating device according to the invention, an insulating sleeve having leakage path-extending shields is arranged on the housing. This is an advantage because the separating device can thereby be made particularly short, which saves on installation space and reduces bending forces in the case of a protruding arrangement of the arrester and the separating device. In this design, the separating device may be configured particularly well as a holding arm or insulating bracket for an arrester.

In another preferred embodiment of the separating device according to the invention, the insulating sleeve at least partially comprises silicone rubber. This is an advantage because silicone rubber is hydrophobic, long-established and durable.

In another preferred embodiment of the separating device according to the invention, a first connecting device is provided at a first end of the separating device in order to connect the separating device to a suspension. The suspension may, for example, be configured as an overhead line pylon or a wall. The suspension fixes the separating device in position and separates it from the ground.

In another preferred embodiment of the separating device according to the invention, a second connecting device is provided at a second end of the separating device in order to connect the separating device to a surge arrester. The connecting device may, for example, be configured as a profile section made of a flexurally strong and electrically conductive material, for example of aluminum or steel. The profile section may comprise a first part, which may be arranged vertically and is used for connecting the separating device in a horizontal position. A second part may be provided, which may be arranged horizontally and is used for connecting the surge arrester in a horizontal position.

In another preferred embodiment of the separating device according to the invention, the second connecting device is configured in order to form an angle of from 10° to 170° between the separating device and a surge arrester. This is an advantage because in this way the separating device on the one hand may separate the current path in the event of a fault and on the other hand may be configured as a holding arm or insulating bracket for an arrester.

In another preferred embodiment of the separating device according to the invention, an essentially right angle is formed. This is an advantage because this design receives the weight of the arrester vertically and is therefore particularly insensitive to oscillations, for example due to wind force.

In another preferred embodiment of the separating device according to the invention, the fuse is configured to break the current path before a maximum short-circuit current is reached. This is an advantage because the surge arrester cannot be loaded with the full network short-circuit current in the event of a fault, which additionally reduces possible sparking. For example, a wire made of a metal, for example copper or silver, may be selected, the thickness of which is dimensioned in simple routine tests so that even a short-circuit current which is above the normal load-bearing capacity of the arrester, but has not yet reached the full network short-circuit current, is thermally sufficient for melting the wire.

In another preferred embodiment of the separating device according to the invention, the fuse is configured to break the current path when temporary surges of a predetermined voltage level and duration occur. For example, a wire made of a metal, for example copper or silver, may be selected, the thickness of which is dimensioned in simple routine tests so that temporary surges are thermally sufficient for melting the wire. This may, for example, be provided for impulse current loading of 100 kA for 4/10 μs. In general, the fuse melting integral should be more than the surge current integral. Typical characteristics of temporary surges are known from the standard IEC 60099-5, Edition 2.0, 2013-05, Chapter 6.2.3.5 on pages 48-53.

In another preferred embodiment of the separating device according to the invention, the fuse is configured not to break the current path when a previously established maximum energy absorption capacity of a connected surge arrester is not exceeded.

In another preferred embodiment of the separating device according to the invention, an arc rotation apparatus is additionally provided. This may, for example, be configured essentially in the form of a plate, as in the documents cited in the introduction, and may for example be provided below the surge arrester, between the surge arrester and the second connecting device. Typically, two of these plate-shaped arc rotation devices are in fact required; one on the high-voltage side and one on the ground side of the arrester. This is an advantage because, in the event that an arc occurs, the arc rotation apparatus can greatly reduce sparking before the separating device has tripped.

In another preferred embodiment of the separating device according to the invention, an indicator apparatus is configured to indicate tripping of the separating device. This may, for example, be a local indicator apparatus which is arranged on the separating device or on a surge arrester.

The indicator apparatus may, for example, be mechanically configured. For example, a coil spring under constraint may be connected to the fusible electrical conductor. An indicator means may be arranged on the coil spring in a guide rail, for example a hollow cylinder. The indicator means may at least partially be provided with a signal color, for example red. During normal operation, i.e. when the conductor is intact, the indicator means is concealed by the cylinder. When the separating device trips, the conductor melts and releases the coil spring. When the coil spring expands, it presses the indicator means at least partially out of the guide rail, so that the signal color becomes visible. This signal color is visible from a distance, and can therefore be seen by maintenance personnel of the operator, so that repair or replacement of the damaged surge arrester and of the separating device may be carried out.

In another configuration, for example, electronic monitoring of the conductor may also be carried out. The indication may also be carried out electronically or optically, for example by switching on a light in a signal color. In this case, an electricity supply is to be provided, optionally with an energy store, for example by means of energy harvesting from the surrounding electromagnetic fields or by solar cells.

Besides a local indicator apparatus, as an alternative or in addition, a central indicator apparatus may additionally be provided. For example, a communication apparatus may be provided on the separating device, which apparatus is configured to transmit a status signal to a server apparatus. The communication device may, in principle, for example use any type of wireless communication, i.e. for example WLAN, GSM, 3G, 4G (LTE), 5G, NFC, Bluetooth, long-range radio, etc. Suitable equipment is already known from the datasheets “Sensformer™ Connectivity Device” and “Sensformer™ Connectivity Device, outdoor version”. Communication by cable (for example Ethernet cable in a substation), optical waveguides or by powerline communication may also advantageously be used.

For example, a cloud application, for example Siemens Mindsphere, may be used as a server apparatus. A status signal which indicates that the separating device has not been tripped (“alive signal”) may, for example, be transmitted daily. If a problem occurs, such as a short circuit which trips the separating device, a fault signal may be transmitted instead. In the cloud application, the operator may centrally monitor all the separating devices and appropriately initiate repairs without having to subject all the separating devices to a visual inspection at regular time intervals. This saves time and money.

On the basis of the known separating device, the object of the invention is also to specify an arrangement having a surge arrester and a separating device, which is comparatively particularly compact, safe and economical to manufacture.

The invention achieves this object by an arrangement as claimed in claim 13. Further advantageous embodiments may be found in claims 14 and 15. The same advantages as elucidated in the introduction for the separating device according to the invention are respectively achieved correspondingly.

A surge protector in the context of the invention comprises varistors (variable resistors), i.e. voltage-dependent resistors. These resistors are often produced in the form of disks, which are stacked on one another and pressed together to form a column. This may, for example, be done by tensioning two end fittings by means of GFRP rods in a so-called cage structure. Tensioning in a tube is also possible. Typically, surge arresters are also configured with an electrically insulating and creepage path-extending housing with shields, made for example of porcelain or silicone rubber.

In the context of the invention, a medium voltage is for example a voltage of between 1 kV and 60 kV.

For better explanation of the invention, in a schematic representation:

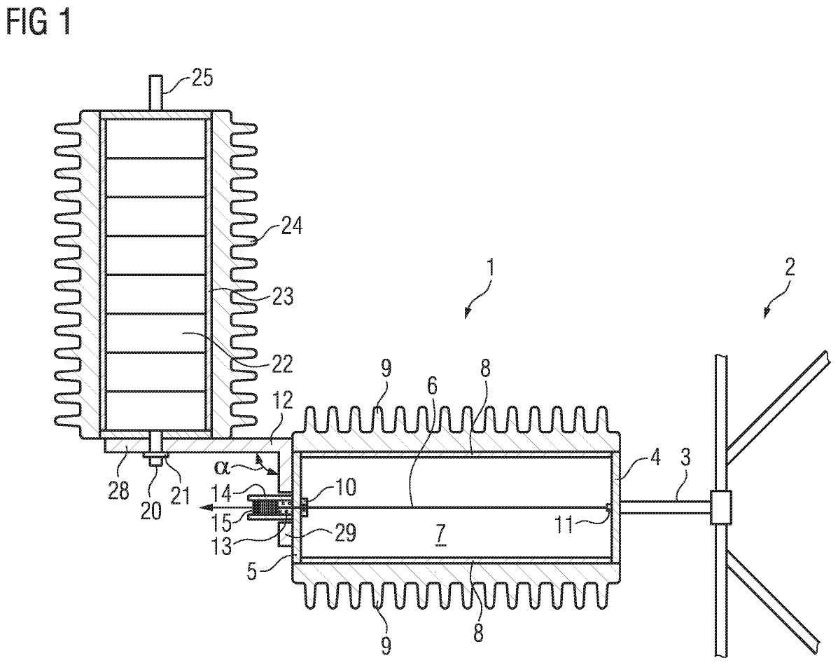

FIG. 1 shows a surge arrester having a separating device according to the invention, and

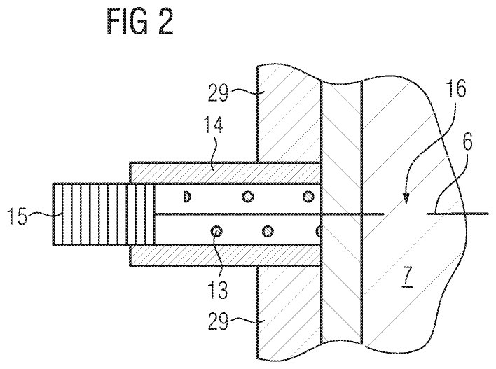

FIG. 2 shows a section of the separating device in the tripped state.

FIG. 1 shows a surge arrester 1 having a multiplicity of varistor disks 22 stacked on one another. These are fixed in a tube 23 between two end fittings. The surge arrester comprises a housing having shields 24, which extend the creepage path. The surge arrester furthermore comprises a first connecting bolt 25 and a second connecting bolt 20. The second connecting bolt 20 is provided with an external screw thread and is fed through an opening in a second connecting device 12. The surge arrester is fixed on the second connecting device 12 by means of a threaded nut 21, which is arranged on the second connecting bolt 20.

A first part, which is used for connecting the surge arrester, of the second connecting device 12 is denoted by the reference 28. A second part 29, which is used for connecting a separating device 1 according to the invention, is arranged at a right angle a to the aforementioned first part 28 of the second connecting device 12. The separating device 1 is configured as a GFRP tube 8. An insulating housing 9 made of silicone rubber, which like the surge arrester is provided with shields, is fitted on the tube 8. The tube 8 is closed on both sides by covers 4, 5. A fuse is arranged inside the separating device 1. For the event of tripping, the latter comprises an electrical conductor 6 which can be melted as a result of a heating effect of a current flow. In the example, the conductor 6 is configured as a thin wire made of silver. The conductor 6 is tensioned between two connecting terminals 10, 11. An insulating material 7, which encloses the conductor, is furthermore provided inside the housing 4, 5, 8 of the separating device 1. For example, the insulating material 7 is at least partially a sand, in particular quartz sand. If a fault event occurs, the conductor 6 melts because of the heating effect and an arc discharge is formed. The arc discharge is in this case formed, in particular, when the metal of the conductor is converted from the liquid state to the gaseous state. The insulating material 7 has the property of rapidly causing the arc discharge to quench, wherein a fusion zone which is formed vitreously is created in the case of a quartz sand. In this way, the electrical connection which previously existed through the conductor 6 is securely DC-isolated and is no longer electrically conductive.

In order to make a fault event visible, a local mechanical indicator apparatus 13, 14, 15 is provided. In the simplest case, this is a tube 14 which is fed through an opening in the part 29 onto the cover 5. A coil spring 13 is held under constraint inside the tube by being compressed by an indicator means 15. The indicator means 15 is connected under constraint to the conductor 6. A holding device 3 is connected to the cover 4 on the side of the separating device 1 facing away from the surge arrester. The holding device 3 connects the arrangement consisting of the surge arrester and the separating device 1 to a schematically indicated suspension 2, which is for example configured as an overhead line pylon.

One great advantage of the arrangement represented is that the separating device 1 with the fuse is simultaneously configured as an insulating bracket, or carrier arm or holding arm, for the surge arrester. This saves material and costs. Furthermore, the explosive charge-free configuration of the separating device entirely prevents the formation of sparks. The arrester represented with the separating device may therefore advantageously be used particularly in climatic regions with a risk of bush fires, for example Australia or California.

FIG. 2 shows a section of the separating device 1 in the tripped state. In this case, the conductor 6 is melted and a disconnection point 16 has been formed. By the tripping of the separating device 1, or by separation of the conductor 6, the coil spring 13 has been able to expand and push the indicator means 15 partially out from the tube 14. Ejection of the indicator means 15 from the tube 14 may, for example, be prevented by a suitable stop (not represented). The indicator means 15 may for example be configured with a signal color, for instance red, so that in the event of tripping it indicates in a way which is visible to maintenance engineers over a large distance that the separating device has tripped and the arrester, or the separating device, needs to be replaced.

1-16. (canceled)

17. A separating device for a surge arrester, the separating device comprising:
a housing; and
a fuse disposed in said housing.

18. The separating device according to claim 17, wherein said fuse, for the purpose of a tripping event, comprises an electrical conductor configured to melt as a result of a heating effect of a current flow, and also an insulating material which encloses said electrical conductor.

19. The separating device according to claim 17, wherein said housing at least partially comprises a glass fiber-reinforced plastic.

20. The separating device according to claim 17, further comprising an insulating sleeve with leakage path-extending shields arranged on said housing.

21. The separating device according to claim 20, wherein said insulating sleeve at least partially comprises silicone rubber.

22. The separating device according to claim 17, further comprising a first connecting device disposed at a first end of the separating device in order to connect the separating device to a suspension.

23. The separating device according to claim 22, further comprising a second connecting device disposed at a second end of the separating device in order to connect the separating device to a surge arrester.

24. The separating device according to claim 23, wherein said second connecting device is configured to form an angle of between 10° and 170° between the separating device and the surge arrester.

25. The separating device according to claim 24, wherein said second connecting device forms a substantially right angle between the separating device and the surge arrester.

26. The separating device according to claim 17, wherein said fuse is configured to break a current path before a maximum short-circuit current is reached.

27. The separating device according to claim 17, wherein said fuse is configured to break a current path when temporary surges of a predetermined voltage level and duration occur.

28. The separating device according to claim 17, further comprising an arc rotation apparatus.

29. The separating device according to claim 17, further comprising an indicator apparatus configured to indicate a tripping of the separating device.

30. An arrangement, comprising:
a separating device according to claim 17; and
a surge arrester connected to said separating device.

31. The arrangement according to claim 30, wherein said surge arrester is configured for medium voltage.

32. The arrangement according to claim 30, further comprising a suspension connecting said surge arrester to said separating device.
